(19) United States
(12) Patent Application Publication
(10) Pub. No.: US 2006/0280300 A1
(43) Pub. Date: Dec. 14, 2006

(54) Cryptographic system

(76) Inventor: Fernando Rossini, Canegrate (MI) (IT)

Correspondence Address: SHERIDAN ROSS PC, 1560 BROADWAY, SUITE 1200, DENVER, CO, 80202, US

(21) Appl. No.: 11/149,129

(22) Filed: Jun. 8, 2005

(51) Int. Cl. H04L 9/00

(52) U.S. Cl. 380/44

(57) ABSTRACT

A cryptographic system is described that comprises a method for the exchange of public keys and the generation of private keys and a message encryption and decryption method via the use of private keys.

This invention refers to an integrated cryptography system including a first algorithm for the creation and exchange of public keys and the generation of private keys, and a second symmetric cryptographic algorithm for the encryption and decryption of a message via the use of private keys.

Various systems of cryptography are currently known, such as the public/private key cryptographic systems (Diffide-Hellman) as disclosed in patent application GB 2 384 403 and the cryptographic systems based on the RSA algorithm (Rivest, Shamir and Adelman) as disclosed in the European Patent granted in publication number EP 0 577 000.

The security of these systems depends on the complexity of the mathematical problem on which they are based. Essentially, there are three known types of mathematical problems:

Integer Factorization Problem (IFP) disclosed in patent application US2003/016823,

Discrete Logarithm Problem (DLP) disclosed in patent application WO97/13342, and

Elliptic Curve Discrete Logarithm Problem disclosed in patent application US2003/0152218.

All of these systems have the drawback of working with prime numbers. As a result, considerable processing power is required for their implementation.

The object of the invention is to eliminate these drawbacks of known art by providing a cryptographic system that is extremely secure and, at the same time, is able to guarantee high processing rate, even on computer systems with limited hardware specifications.

These objectives are achieved in accordance with the invention with the private-key generation method and with the private-key encryption method, the characteristics of which are listed in the independent claims 1 and 8, respectively, enclosed herein.

Advantageous embodiments of the invention are revealed in the dependent claims.

Further characteristics of the invention will appear clearer from the detailed description that follows, referring to its embodiments in a purely exemplifying manner and therefore not limitative.

This invention describes an optimal process for the exchange of public cryptographic keys over insecure communication channels, such as those of current communications media. Private keys are generated via the public keys, without the use of prime numbers, guaranteeing simple implementation and therefore high performance with respect to the current systems of public-key cryptography.

The invention also includes a symmetric algorithm for the encryption and decryption phase of messages via the use of private keys.

### ALGORITHM FOR THE CREATION AND EXCHANGE OF PUBLIC KEYS AND THE generation of PRIVATE KEYS

Scheme of Principle

The system in accordance with the invention uses one or more elementary or complex mathematical functions, the difficulty of which, at a cryptographic analysis level, consists in calculating one or more modular recursive equations in ‘m’ random unknowns.

1 f₁(x₁, x₂, . . . , xₘ)→N₁→R(N)→K₁

2 f₂(x₁, x₂, . . . , xₘ)→N₂→R(N)→K₂

. . . →C(msg)

n fₙ(x₁, x₂, . . . , xₘ)→Nₙ→R(N)→Kₙ

In this scheme, n functions f₁(x₁, . . . , xₘ), f₂(x₁, . . . , xₘ), . . . , fₙ(x₁, . . . , xₘ) are utilized for m unknowns x₁, x₂, . . . , xₘ, where n and m can be any integer numbers. From the n functions f₁, . . . , fₙ, n public keys N₁, . . . , Nₙ are obtained that are inserted in the respective functions R(N) to obtain one or more private keys K₁, K₂, . . . , Kₙ which are used for encrypting a message C(msg).

The functions f₁, . . . , fₙ selected for inserting in the scheme can be freely chosen, but must be reversible. Each function must be recursive (in n) and create a complex numeric set to be disaggregated (inverted), as the disaggregation (inversion) can only be performed by the holder of the private values (unknowns).

An example of a function with three unknowns f (x, Y, M) to be used in the above-indicated scheme could be:

$$f ( x , Y , M ) = {\sum }_{j = 1}^{n} ( ( g ⋀ xj * Yj ) mod Mj ) mod P \qquad ( 1 )$$

with: g, P, xj, Yj, Mj ε

[symbol]

g and P are known values (public values given by the users of the system),

xj, Yj and Mj are unknown values that are randomly generated using a pseudo-random number generator, such as a multiplicative congruential generator for example.

Even if in this case the function ƒ(x, Y, M) has three unknowns (x, Y, M), for simplicity, it will be indicated in the following as f(x), on the understanding that any number of unknowns can be used. In this case, by applying expression (1) as the index j of the summation changes, it is possible to obtain n different functions in three unknowns.

When the numeric values of the unknowns (x, Y, M) are inserted, each single function f(x) generates an integer N that represents the exchangeable public key according to the Diffie-Hellmann scheme. Furthermore, the result of a single function f(x) can provide the input for calculating a successive function according to the following recursive relation:

$$R ( N ) = kn = {\sum }_{j = 1}^{n - 1} f ( kj ) + f ( xn ) \qquad ( 2 )$$

Clearly, the recursive relation (2) can be constructed in a different manner; for example, the addition operator (+) could be substituted by a division operator (/).

In this manner, n separate private keys K₁, K₂, . . . , Kₙ are calculated from function (2). In practice, each single public key N₁, N₂, . . . Nₙ (derived from a single function f₁(x), f₂(x), . . . , fₙ(x)) serves to generate not only n private keys K₁, K₂, . . . , Kₙ, but also a unique private key Kp given by the following concatenation relation:
Kp=K₁∥K₂∥K₃ . . . ∥Kₙ (3)
giving rise, in this way, to a large numeric value for Kp.
Public Keys Exchange Process

The exchange of public keys (N₁, N₂, . . . Nₙ) between two users A and B, takes place according to the following method:

1. User A sends his public key (α=N_{A}) to user B.

2. User B sends his public key (β=N_{B}) to user A.

3. Users A and B separately calculate the private keys (Kp₁, Kp₂, . . . Kpₙ), via the recursive function (R(N)) (2), according to the above-described calculation scheme.

The private keys (Kp_{A} and Kp_{B}) calculated by users A and B will be equal. With this private key (Kp_{A}=Kp_{B}) equal for A and B it is possible to start the message encryption/decryption process.

$$\begin{matrix}\underline{Scheme of process for exchange of public keys} \\ \underline{and generation of private key}\end{matrix}$$

$$\begin{matrix}User \text{-} A & & & \text{User-} B \\ & \to & α = f ( {x}_{A} ) & \\ & β = F ( {x}_{B} ) & ← & \\ ⇒ & R ( {x}_{B} , β ) = {Kp}_{A} = {Kp}_{B} & R ( {x}_{B} , α ) = {Kp}_{B} = {Kp}_{A} & ⟸\end{matrix}$$

According to this scheme:

User A sends his public key α=f(g, P, x_{A}) (obtained by inserting the public values (g, P) known to both users A and B and the values of the unknowns (x_{A}) randomly generated by user A in expression (1)) to user B.

User B sends his public key β=f(g, P, x_{B}) (obtained by inserting the public values (g, P) known to both users A and B and the values of the unknowns (x_{B}) randomly generated by user B in expression (1)) to user A.

User A inserts his known values (g, P, x_{A}) and the public key β sent to him by user B into expression (2), in order to obtain his private key Kp_{A}=R(g, P, x_{A}, β).

User B inserts his known values (g, P, x_{B}) and the public key α sent to him by user A into expression (2), in order to obtain his private key Kp_{B}=R(g, P, x_{B}, β).

In conformity with the method in which the recursive function (2) has been constructed, the outcome must be Kp_{A}=Kp_{B} and this private key value can be used to encrypt/decrypt a message.

A numeric example with an equation f(x) in 3 unknowns (v1, v2, v3) is described in the following.

User-A and User-B know the public values g=7 and P=224 that have been previously exchanged.

The function (1) is given by the simple expression:
f(x)=(g+v1*v2)+v3 mod P

User-A obtains 3 unknown values: v1a=125, v2a=3 and v3a=11

User-B obtains 3 unknown values: v1b=95, v2b=2 and v3b=15

These unknown values can be randomly entered by User-A and User-B, or can be generated by a random number generator.

Calculation of Public Keys (α and β):

User-A calculates his public key a applying expression (1):
α=f(v1a, v2a, v3a)=(g+v1a*v2a)+v3a mod P
α=(7+125*3)+11 mod 224=393

User-B calculates his public key β applying expression (1):
β=f(v1b, v2b, v3b)=(g+v1b*v2b)+v3b mod P
β=(7+95*2)+15 mod 224=212
Exchange of Public Keys (α and β) and Calculation of the Private Key (Kp_{A} and Kp_{B}):

User-A enters the public values g and P, his random unknowns v1a, v2a, v3a, and the public key β sent by User-B, into the recursive expression (2). In this way, User-A obtains his private key Kp_{A}.
Kp_{A}=R(g, P, v1a, v2a, v3a, β)=(g+β+v1a*v2a)+v3a mod P
Kp_{A}=(7+212+125*3)+11 mod 224=605

User-B enters the public values g and P, his random unknowns v1b, v2b, v3b, and the public key α sent by User-A, into the recursive expression (2). In this way, User-B obtains his private key Kp_{B}.
Kp_{B}=R(g, P, v1b, v2b, v3b, α)=(g+α+v1b*v2b)+v3b mod P
Kp_{B}=(7+393+95*2)+15 mod 224=605

Finally, the private key Kp_{A} obtained by User-A corresponds to the private key Kp_{B} obtained by User-B, i.e. Kp_{A}=Kp_{B}=605.

It should be borne in mind that the security of the cryptography system in accordance with the invention is based not only on the chosen mathematical function (such as in the RSA algorithm for example, or in similar systems), but also in its logical conception or scheme of operation.

The cryptography system in accordance with the invention utilizes medium-small sized numbers in the calculation phase, of the order of ˜12-64 digits (or more), and thus of smaller numerical space with respect to the sizes of numbers utilized by other systems of cryptography, such as the ECDLP system (elliptic curves).

This system can be implemented on calculating devices provided to User-A and User-B. In fact, it is sufficient that these calculating devices are equipped with a memory and means of calculation suitable for:

generating random numbers,

calculating function (1) for returning the public keys, and

calculating function (2) for returning the private keys.

### Symmetric Encryption and Decryption Algorithm

Once the private keys (Kp) are obtained, they can be used to encrypt a message and then decrypt it, via a symmetric algorithm in accordance with the invention. This symmetric algorithm is not limited to the private keys Kp obtained with the system in accordance with the invention, but can be used with any private key, obtained in any manner whatsoever.

The symmetric algorithm in accordance with the invention is fundamentally based on 4 functions:

a. Modulus 32 logical addition of bytes (b1, b2, b3, b4) (in groups of 4) of the clear text to encrypt,
fa=b1+b2+b3+b4 (4)

b. 2ⁿ−1 complement of a random segment of n bits (sb),
fb=(2ⁿ−1)−(sb) (5)

c. Logarithmic function,
fc=Integer(log(mj)/log(kj)/kj)*k1j)−k2j (6)
in which mj is the message to encrypt after having been opportunely processed by the functions (4) and (5), and kj, k1 and k2 are the private keys utilized for the encryption of the message mj.

d. Modulus 2⁸ addition/subtraction of the output bits.
fd=fc+k1j mod k2j (7)

To better clarify the operation of the symmetric algorithm in accordance with the invention, a real example is provided in the following, assuming the desire to encrypt the word “LOVE”.

Extracting the corresponding values of each letter that forms the word “LOVE” from the ASCII International Code Table, one thus obtains:

L=76, O=79, V=86, E=69

For a total of 4 byte (characters), equal to 4×8=32 bit, where 1 byte=8 bit.

Each digit is transformed into a binary value, giving:

a1=76=01001100 a2=79=01001111

a3=86=01010110 a4=69=01000101

The four binary values (a1, a2, a3, a4) obtained are joined together via concatenation to give a 32-bit binary string:

S=b1∥b2∥b3∥b4=01001100010011110101011001000101

This 32-bit binary string S still represents the word “LOVE”.

Now, it is presumed to obtain 2 random integer segments S1=20 and S2=12, such that their sum is 32.

The maximum value of S1=20 bits expressed in decimal format is 2²⁰−1=1048575

The maximum value of S2=12 bits expressed in decimal format is 2¹²−1=4095

Now the binary string S is divided into 2 binary segments, the first X1 of 20 bits and second X2 of 12 bits, having lengths equal to the values of the random segments S1 and S2, giving:

X1=01001100010011110101

X2=011001000101

The first binary segment X1 and the second binary segment X2 are respectively converted into the corresponding decimal values:

X1=01001100010011110101=312565

X2=011001000101=1605

At this point, applying function (5) carries out the 2ⁿ−1 complement of the two decimal segments, where 2ⁿ−1 equals 1048575 for the first segment and 2ⁿ−1 equals 4095 for the second segment. In this way, two numeric values (y1 and y2) are obtained:

y1=X1 comp 2ⁿ−1=1048575−312565=736010

y2=X2 comp 2ⁿ−1=4095−1605=2490

The obtained values (y1=736010 and y2=2490) are transformed back into binary, compensating, if necessary, with 0 bits to left if the number of bits is less than that of the original random segments S1 and S2:

y1=736010=10110011101100001010

y2=2490=100110111010

In this way, two new binary segments y1 and y2 are obtained, which are then joined via concatenation, so as to form a new binary string Y, always of 32 bits:

Y=y1∥y2=1011001110110000101011100110111010=10110011101100001010100110111010=32 bits

At this point, the binary string obtained Y is divided into 4 binary strings (b1, b2, b3, b4) of 8 bits:

b1=10110011 b2=10110000 b3=10101001 b4=10111010

The 4 binary strings (b1, b2, b3, b4) are respectively transformed into 4 decimal numbers that correspond to the decimal numbers of the ASCII system, giving:

b1=10110011=179 b2=10110000=176

b3=10101001=169 b4=10111010=186

The 4 decimal values obtained (b1, b2, b3, b4) are inserted in the fa function (4), that is to say the MOD 32 logical sum function, which is able to return a single number C that represents the logical sum of the 4 decimal values (b1, b2, b3, b4), in the range between −A and A′, where A=2,147,483,648 and A′=2,147,483,647. This range between −A and A′ is given by all of the possible combinations of values that can be obtained with 4 bytes.

In this example, the numerical values obtained in output from function (4) is
C=fa=b1+b2+b3+b4=−1,280,267,846
where −A<C<A′.

A random value D is obtained, via a random number generator, that is greater than |−A|=2,147,483,648 and less than or equal to B=6,999,999,999, where B is a number set by the programmer to give an upper limit.

In this example, the random number generator issues the value D=6,217,420,393 where A<D<B.

Therefore, performing the complement of C with D gives:
M=D−(−C)=6,217,420,393−(−1,280,267,846)=7,497,688,239

(Note that the complemented value M is always positive). The obtained value M is used as the Base in the logarithmic function (6).

At this point, two private keys (K0, K1) are introduced for the actual encryption. The private keys are forced with the addition of zeroes or other digits to the right to satisfy the following requirements: K0 always consists of a 12-digit number and K1<K0.

In this example, the private keys K0=375,320,982,970 and K1=282,919,125 have been used. The result M of the message to be encrypted, the two private keys K0 and K1, and an approximation constant k3 for approximating the result to the nearest integer are then inserted in the logarithmic function (6). In this case, the approximation constant k3 is equal to 0.5. One thus obtains:
H=fc=Integer((log(M)/Log(K0))*K0+k3)−K1==Integer((Log(7497688239)/Log(375320982970))*375320982970+0.5)+−282,919,125=319,929,492,686

Note that usually this function (6), in observance of the conditions, always provides a number H formed by 12 digits, but, in cases where it is smaller, it should be compensated with 0 (zeroes) to the left.

The value H obtained is divided into groups of 2 digits each, thereby obtaining 6 groups of 2 digits:
P=319929492686=31, 99, 29, 49, 26, 86

Finally, function (7) is used, namely the 2⁸ (=256) modulus function for obtaining the final cryptogram, having previously obtained 6 random keys between 0 and 255, via a random number generator. In the following example, the random keys are:

KA=200, KB=183, KC=77, KD=127, KE=91 and KF=173

Applying function (7), one obtains:

C1=31+200 MOD 256=231

C2=99+183 MOD 256=26

C3=29+77 MOD 256=106

C4=49+127 MOD 256=176

C5=26+91 MOD 256=117

C6=86+173 MOD 256=3

The final cryptogram is obtained by retransforming the obtained values C1, C2, . . . C6 into ASCII characters and concatenating them, which in the case of the original word LOVE, is equivalent to: ç_j°u_{—}

To reacquire the original word LOVE in clear text, it is sufficient to repeat the steps of the previously explained functions (7), (6), (5) and (4) in reverse order.

By way of example, the Code of MOD 32 logical sum function (4) is specified below.

Function F(a) for the Encryption Step

Fa=(b1, b2, b3, b4)

Fa=((b1 And &H7F)*&H1000000) Or (b2*&H10000) Or (b3*&H100) Or b4

If b1 And &H80 Then

Fa=Fa Or &H80000000

Inverse Function Fa for the Decryption Step

Fa⁻¹=(Fa, b1, b2, b3, b4)

b1=((Fa And &HFF000000)\&H1000000) And &HFF

b2=((Fa And &HFF0000)\&H10000) And &HFF

b3=((Fa And &HFF00)\&H100) And &HFF

b4=(Fa And &HFF) And &HFF

Return b1, b2, b3, b4

The cryptography system in accordance with the invention can be implemented on any computer using any programming language. Given the reduced memory occupation and high speed of calculation, this cryptography system can be integrated at hardware level, even in small-sized devices such as palmtops, mobile phones, smart cards and similar.

The cryptography system in accordance with the invention can be utilized in any field where there is the need to exchange encrypted data, such as the Armed Forces for example, or research/university institutes, post and telecommunications services, industry, banks and credit institutions, e-commerce, regional/provincial/local authorities, hospitals and similar.

Variations and detail changes within the reach of a person skilled in the art can be applied to these embodiments, such variations and changes falling, in any case, within the scope of the invention expressed by the enclosed claims.

1. A method for the generation of private keys for performing the encryption/decryption of a message, via a calculating device including memory media and means of calculation suitable for calculating the result of at least a first function (f(x)) for the generation of public keys and a second function (R(N)) for the generation of private keys, the method including the following steps:
exchange of two public values (P and g), in the form of numeric or alphanumeric digits, between two users, User-A and User-B, and storage of said public values (P and g) on memory media of the respective calculating devices of User-A and User-B,
calculation of the respective public keys (α and β) via said at least first function (f(x)) on the calculators of User-A and User-B, inserting said public values (g and P) known to both of them and values (v1a, v2a, v3a, v1b, v2b and v3b) randomly generated by User-A and User-B respectively, into said first function (f(x)),
exchange of calculated public keys (α and β) between User-A and User-B and storage of said public keys (α and β) on the respective memory media,
calculation of the private key (Kp_{A}) by the calculator of User-A, inserting said public values (g and P) known to both, said values (v1a, v2a and v3a) randomly generated by User-A and said public key (β) sent by User-B, into the second function (R(N)), and
calculation of the private key (Kp_{B}) by the calculator of User-B, inserting said public values (g and P) known to both, the values (v1b, v2b and v3b) randomly generated by User-B and the public key (α) sent by User-A, into the second function (R(N)),
in which the value of the private key (Kp_{A}) calculated by the calculator of User-A is equal to the value of the private key (Kp_{B}) calculated by the calculator of User-B.

2. The method according to claim 1, characterized in that said random values (v1a, v2a, v3a, v1b, v2b and v3b) inserted in said at least one first function (f(x)) and said second function (R(N)) are calculated via a random number generator forming part of the means of calculation.

3. The method according to claim 1, wherein said at least one first function (f(x)) and said second function (R(N)) are recursive and/or reversible functions.

4. The method according to claim 3, wherein said second function (R(N)) for obtaining the private keys is given by the relation:
$$R ( N ) = kn = {\sum }_{j = 1}^{n - 1} f ( kj ) + f ( xn )$$
where k is the private key and f is the said first function.

5. The method according to claim 3, wherein said second function (R(N)) for obtaining the private keys is given by the relation:
$$R ( N ) = kn {\sum }_{j = 1}^{n - 1} f ( kj ) / f ( xn )$$
where k is the private key and f is the said first function.

6. The method according claim 1, wherein said at least one first function (f(x)) for obtaining the public keys is given by the relation:
$$f ( x , Y , M ) = {\sum }_{j = 1}^{n} ( ( g ⋀ xj * Yj ) mod Mj ) mod P$$
with: g, P, xj, Yj, Mj ε [symbol] , where g and P are said public values given by the users and xj, Yj and Mj are said values randomly generated by the users.

7. The method according to claim 1, wherein said private keys (K₁, K₂, . . . , Kₙ) obtained from said second function (R(N)) are concatenated together to obtain a single private key (Kp).

8. The method for the encryption/decryption of a message (m) via private keys (k), by the use of a calculator possessing memory media and calculating means, the method including the following steps:
storage of message (m) on said memory media,
division of message (m) into groups of four letters,
transformation of each letter into a binary number (a1, a2, a3, a4) corresponding to the relative ASCII code,
concatenation of said binary numbers in a manner to form a 32-bit string S,
generation of two random numeric segments (S1 and S2) the sum of which is 32,
division of string (S) into two binary segments (X1 and X2) having a number of bits equal to the random segments (S1 and S2),
conversion of the binary segments (X1 and X2) into decimal format and 2ⁿ−1 complement in order to obtain two numeric values (y1 and y2) that are transformed into binary and concatenated in a manner to obtain a 32-bit string (Y),
division of said string (Y) into four binary strings (b1, b2, b3 and b4) that are transformed into decimal format,
modulus 32 logical addition of said four strings (b1, b2, b3 and b4) in order to obtain a numeric value C that is complemented with a random value D greater than 2,147,483,648 in order to obtain a numeric value M indicative of the message to encrypt,
use of said numeric value (M) obtained, as the base of a logarithmic function (fc) of encryption within which said private keys (K0 and K1) are inserted, in order to obtain a 12-digit numeric value (H),
division of said numeric value (H) into six groups of two digits, and
2⁸ modulus addition/subtraction of said six groups of two digits with six random constants (KA, KB, KC, KD, KE and KF) between 0 and 255, in order to obtain six numeric values (C1, C2, C3, C4, C5 and C6) that transformed into ASCII characters generate the desired cryptogram.

9. The method according to claim 8, wherein said logarithmic function (fc) of encryption is given by the following expression:
fc=Integer(log(mj)/log(kj)/kj)*k1j)−k2j
where mj is said numeric value (M) indicative of the message to encrypt, and kj, k1j and k2j are said private keys.

10. The method according to claim 8, wherein two private keys (K0, K1) are inserted in said logarithmic function (fc) of encryption, in which the first private key (K0) is formed by a 12-digit number and the second private key (K1) is less than the first private key (K0).

11. The method according to claim 8, wherein an approximation constant (k3) for approximation to the nearest integer is inserted in said logarithmic function (fc) of encryption.
